(19) United States
(12) Patent Application Publication
(10) Pub. No.: US 2011/0191478 A1
(43) Pub. Date: Aug. 4, 2011

(54) QUICK ACCESS DISPLAY

(75) Inventors: Todd M. Eischeid, Cary, NC (US); Daniel P. Kelaher, Holly Springs, NC (US); Jeffrey J. Smith, Raleigh, NC (US); David T. Windell, Raleigh, NC (US)

(73) Assignee: International Business Organization Name Machines Corporation, Armonk, NY (US)

(21) Appl. No.: 12/696,262

(22) Filed: Jan. 29, 2010

(51) Int. Cl. G06F 15/16; G06F 1/16; G06F 3/048; G06F 13/38

(52) U.S. Cl. 709/227; 361/679.26; 715/764; 710/63

(57) ABSTRACT

A quick access display with a small screen is physically attached to the outside of a laptop computer. Selected and key information in formatted display frames is electronically pushed to the quick access display by an application program loaded to run on the laptop computer's operating system. The formatted display frames are communicated over a universal serial bus (USB), or wirelessly by radio frequency identification (RFID) chips, BLUETOOTH, or IEEE-802.11 Wi-Fi. Operating power for the quick access display is provided by long-life watch batteries and the electronics are implemented in low power MOS technologies.

### BACKGROUND OF THE INVENTION

1. Field of the Invention

The present invention relates to computers, and in particular, to secondary monitors for attachment to computers that provide a quick, ready display for key data about the computer or information it is storing.

2. Background Information

Laptop computers and PDA's have taken over the traditional role of the personal organizer in a binder in which executives and professionals kept key information about their business appointments, conference call-in numbers, calendar, address book, and maps. However, personal organizers still excel in one regard, the information inside is easy to access by simply flipping open the binder.

Conventional computers and PDA's have to be on and booted up in order to be accessible and useful. It often seems too tedious or time-consuming to boot-up a laptop computer just to get a client's phone number from an address book or the street address of the appointment you're traveling to. Also, during manufacturing, it may be impractical or impossible to access one of the many part numbers, serial numbers, and version numbers for the hardware, operating system, and applications obscured within.

Getting diagnostic information also usually means the computer must be booted up, in order to run the diagnostic. Of course, many faults can interfere with a boot-up and prevent the diagnostic from running or reporting critical information.

What is needed is a device that provides a quick ready display of selected and key information about a computer it's attached to, without having to power up the computer or waiting for it to boot, or having to navigate to the places that can supply the information.

### SUMMARY OF THE INVENTION

A quick access display with a small screen is physically attached to the outside of a laptop computer. Selected and key information in formatted display frames is electronically pushed to the quick access display by an application program loaded to run on the laptop computer's operating system. The formatted display frames are communicated over a universal serial bus (USB), or wirelessly by radio frequency identification (RFID) chips, BLUETOOTH, or IEEE-802.11 Wi-Fi. Operating power for the quick access display is provided by long-life batteries and the electronics are implemented in low power MOS technologies.

Selected reference data and information is constantly available for viewing on a small secondary display panel on the outside surface of a laptop computer or notebook. As such, the delays, inconvenience, and power needed to open up and boot-on the portable device just to access some small, but critical, piece of information are avoided. The quick access display has its own independent source of power so the laptop computers and notebooks can be completely powered down. Since the quick access display need not compute anything, nor present high resolution frames or video, extremely low frequency system clocks can be used with CMOS digital logic, flash memory, and liquid crystal or e-ink displays to bring power consumption levels down to those on the order of a quartz LCD wristwatch and watch battery. Buttons are provided when there is too much information for a single screen to display all of it at once, and the buttons allow a deck of information “cards” to be shuffled through. The screen formats and data for the quick access display can be predetermined by the user's preferences and an application program hosted on the laptop computer's or notebook's operating system.

### BRIEF DESCRIPTION OF THE DRAWINGS

FIG. 1 is a perspective view diagram of a quick access display embodiment attached to a laptop computer;

FIG. 2 is a functional block diagram of a quick access display embodiment; and

FIG. 3 is a functional block diagram of a laptop computer and a smartphone with downloadable software program embodiments that allow the smartphone to function as a high availability tote board for selected data monitored in what can be a low availability laptop computer.

### DESCRIPTION OF THE PREFERRED EMBODIMENTS

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

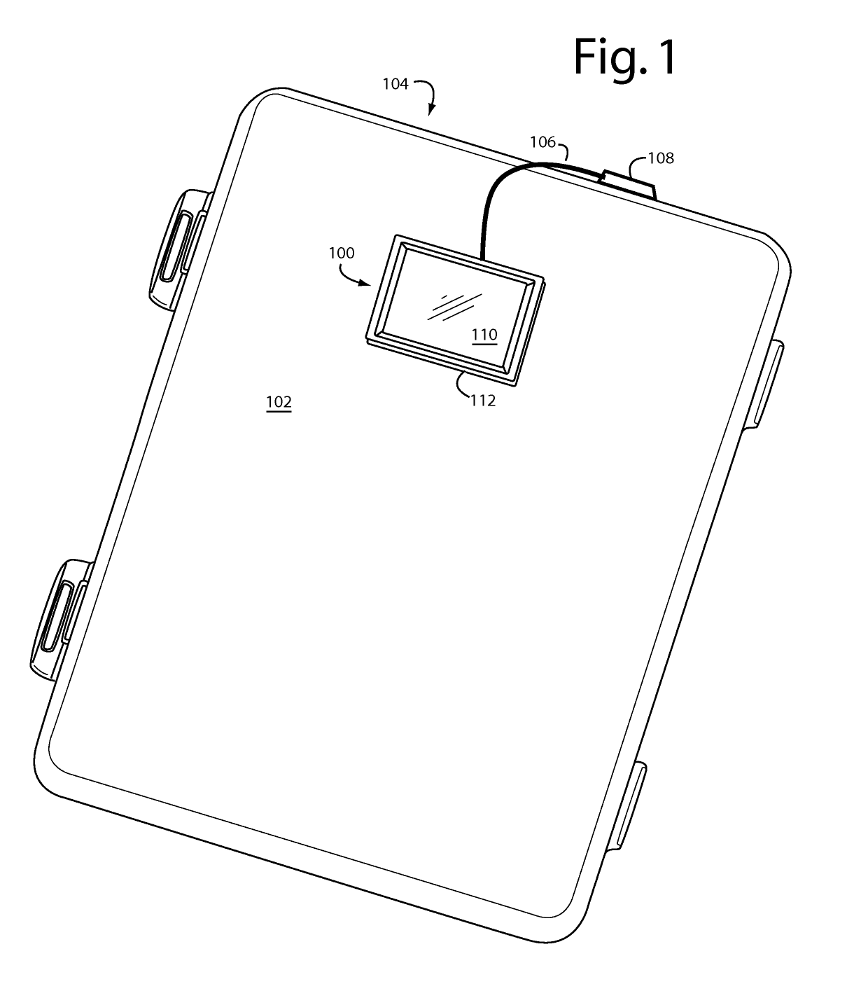

FIG. 1 represents a quick access display 100 attached to an outside surface 102 of a notebook or laptop computer 104 that has its own “primary” viewing display screen. The quick access display 100 has a cable 106 attached through a universal serial bus (USB) connector 108 to a mating connector on one side panel of laptop computer 104. The quick access display 100 comprises a “secondary” display screen 110, e.g., a 3″ diagonal size color, active-matrix thin film transistor (TFT) liquid crystal display (LCD) screen 110 set in a plastic housing and mount 112. The backside of plastic housing and mount 112 is flat and is semi-permanently attached by user to surface 102 with a double-sided acrylic adhesive foam mounting tape, e.g., 3M® brand VHB™ tape. Alternatively, display screen 110 and mount 112 are implemented in a flat thin membrane with a pressure sensitive adhesive surface for attachment to the notebook or laptop computer 104. A supporting digital memory, power source, and communications device are also all disposed within such flat thin membrane.

Laptop computer 104 has to be powered on and booted up in order to be accessible and useful. That can take time the user may not have, and power the laptop battery cannot afford. And during the manufacturing of laptop computer 104, it may be impractical or impossible to access one of the many part numbers, serial numbers, and version numbers for the hardware, operating system, and applications obscured within.

A less desirable mounting method, in terms of cost and universality of application, would be to provide a snap-in pocket for flush mounting of quick access display 100 into laptop computer surface 102. An advantage of that solution is that it is able to run cable 106 internally to a private USB connection inside laptop computer 104.

It is important that display screen 110 use low power technology so quick access display 100 can operate for months or more on a small rechargeable or coin-cell type battery, such as a watch battery. For example, less than a hundred microwatts of operating power with a battery as large as 1000 milli-amp hours. It is also important that quick access display 100 not depend on laptop computer 104, or any host it's attached to, to supply its operating power. It would be acceptable, however, if the laptop computer 104 or any host it's attached to were able to recharge a battery inside quick access display 100, as is commonly done with cellphones having USB connectors.

The circuit layout of a TFT-LCD display is very similar to that of a DRAM memory. Instead of fabricating the transistors from a crystalline wafer of silicon, the transistors are made from a thin film of silicon deposited on a glass substrate. The transistors themselves take up only tiny areas in each pixel, and large areas of unused silicon film are etched away for light to pass through as a display image. A principal way to conserve battery power is with backlight power management. Other, developing, low-power display technologies will extend the battery life of the quick access display 100 even more than is described herein.

It would be advantageous if the quick access display 100 received electronic data pushed to it using some communication technology already in popular use with laptop computers. For example, serial I/O, USB, Firewire, parallel port, BLUETOOTH, wireless near field communication (NFC), or IEEE-802.11 Wi-Fi. It further would be advantageous if the quick access display 100 physically attached to ordinary laptop computers in some quick, simple, and inexpensive way. For example, in a credit card form factor and thickness with a sticker, VELCRO, or double-sided sticky tape could be used to attach the quick access display 100 to the computer surface 102.

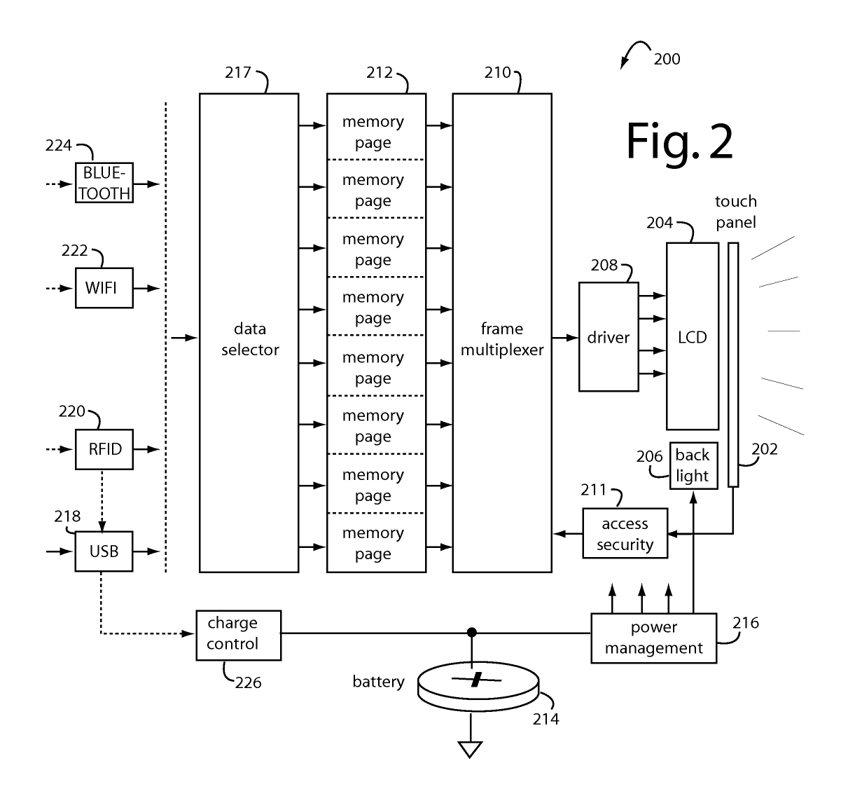

FIG. 2 represents a quick access display 200, like that of FIG. 1. Here, quick access display 200 includes a touch panel 202 in front of an LCD 204 with a backlight 206. An LCD driver 208 is provided formatted screen page image data through a frame multiplexer 210. An access security device 211 requires the user to input a password to prevent unauthorized viewing of some or all of the information stored within. For example, the user taps on touch panel 202 to keypad a password and then indicate which of several pages or cards of information in a page memory 212 they want to see displayed. Page memory 212 is implemented with a digital semiconductor and non-volatile memory technology that requires less than a hundred microwatts of operating power. Non-volatility can be achieved through the use of a battery.

Tapping on touch panel 202 will also cause backlight 206 to turn on briefly. Power from a coin-cell type replaceable battery 214 is thus conserved by limiting how long backlight 206 operates. Backlight 206 and all the other power loads are controlled by a power manager 216. Low power operation requires that the digital electronics used in the implementation be all static, with no clocks or refresh cycles. CMOS digital technology would be a good choice.

Two important characteristics of CMOS devices are high noise immunity and low static power consumption. Significant power is only drawn while the transistors in the CMOS device are switching between on and off states. Consequently, CMOS devices do not produce as much waste heat as other forms of logic, for example transistor-transistor logic (TTL) or NMOS logic, which uses all n-channel devices without p-channel devices. CMOS also allows a high density of logic functions on a chip.

Memory pages in page memory 212 have bits that map into each pixel of LCD 204. Here, eight memory pages are represented, signifying that LCD 204 can display eight different preformatted pages or cards. Some of the bits or pixel positions are static and used to erect structures and field labels that probably do not need to change much over the service life of a particular quick access display. Other bits and pixel locations are painted with data variables that can change periodically, according to what a user has selected as important information to be available on the quick access display 100 or 200. The overall effect resembles a tote board. That, however, would not prevent LCD 204 from being used to display photos, barcodes, or graphics. Barcodes may be presented on the secondary screen display, quick access display 100 or 200, that represents identification and/or health data. It is further advantageous to include a screen grabber for simulating and memorializing at least some portion of an image frame presented on the primary screen display of laptop computer 104 on the secondary screen display 110, or 204.

An application program loaded onto the laptop computer manages the selection of what bits of information existing in a laptop computer 104 and the drivers to push that data to quick access display 100 or 200. A data selector 217 allows such application program to address and store the information to the several memory pages. A USB device 218 can be configured with a quick access display device driver for a MICROSOFT WINDOWS® operating system that would load automatically when it was plugged in. The system and its firmware should comply with the Advanced Configuration and Power Interface Specification (ACPI), which is an open industry standard. The driver architecture for Windows supports comprehensive, operating system-controlled Plug and Play. Plug and Play technologies are defined for IEEE 1394, PCI, PC Card/CardBus, USB, SCSI, ATA, ISA, LPT, and COM. The technology is therefore conventional and need not be described further here.

USB device 218 is one of several input devices that could be used to receive tote-board type push data from a laptop computer 104 or other appliances and platforms. Wireless devices can be used for data input, including an RFID receiver tag 220, a WiFi IEEE 802.11-type receiver 222, and a BLUETOOTH device 224. One advantage in using a USB device 218 is that laptop computer operating power can be tapped with conventional means and put through a charge controller 226 to charge battery 214 whenever laptop computer 104 is powered on.

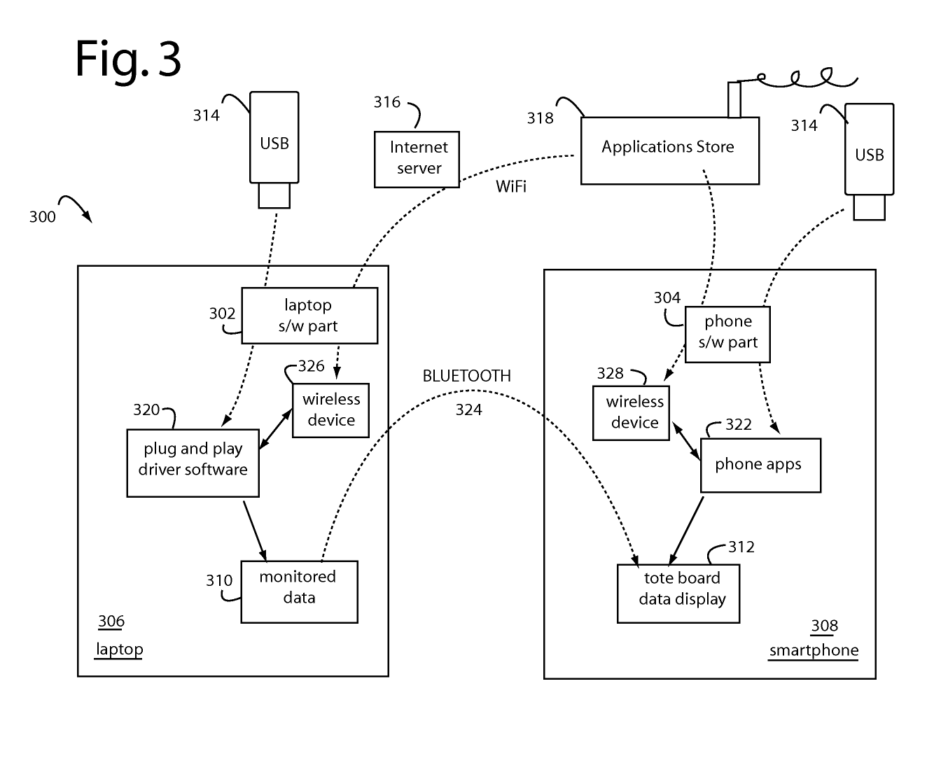

FIG. 3 represents a different hardware implementation of the same idea behind FIGS. 1 and 2. The hardware is all preexisting and the embodiment comprises software that loads onto conventional hardware. Essentially, an application program is provided for execution by a first portable device, its operating system, and a second portable device. Selected data is wirelessly forwarded to the digital memory of the second portable device for later viewing on a “secondary” display screen when the “primary” display of the first portable device is unavailable. In this embodiment, low power digital circuitry and battery power conservation are not a concern.

A quick access tote board software 300 has two parts, a laptop computer part 302 and a smartphone part 304 that communicate between themselves wirelessly using BLUETOOTH or similar technology. The overall purpose is the same as in the implementations of FIGS. 1 and 2, a portable, laptop computer 306 has many different data points 310 like cells in a spreadsheet being monitored that need to be memorialized and made accessible to the laptop computer user on a tote board kind of display 312. Such display 312 needs to have a high and quick availability, because the laptop computer 306 and its secrets are often dark and not available. Some data, will typically need to be secure because it is personal, confidential, valuable, or otherwise deserving of protection. A common mobile phone or smartphone 308 is a high availability device, and just about every user is likely to have one on their person nearby laptop computer 306, and it will be on and operating. Some people keep their smartphones on and within easy reach 24-hours a day, 7-days a week. Smartphone 308 and its data contents can be readily secured using conventional means.

As of 2009, just about every laptop computer being sold in the United States is equipped with USB, Wi-Fi, and BLUETOOTH technology. The same is true for many cellphones and smartphones. The quick access tote board software 300 therefore can operate as intended with unmodified hardware and standard commercial off-the-shelf consumer products like laptop computer 306 and smartphone 308. The laptop computer software part 302 and smartphone software part 304 are embodied as computer program files downloaded from a USB fob flash drive 314, an Internet server 316, and/or an Applications Store 318 like the Apple iPhone store at http://www.apple.com/iphone/apps-for-iphone/. These respectively become a plug and play driver 320 and a phone app 322. Particular embodiments include a screen grabber function in the plug and play driver software 320 for simulating and memorializing at least some portion of an image frame presented on the primary screen display of laptop computer 306 onto a “secondary” screen display of smartphone 308. The remaining devices and functions usual to laptop computers and smartphones are not shown in FIG. 3, and are conventional.

The plug and play driver 320 allows the user to select various data available to laptop computer 306 that are to be included in monitored data 310. The phone app 322 allows the smartphone user to see what's being reported on the tote board data display 312.

BLUETOOTH communication 324 and wireless devices 326 and 3284 runs as a background process that constantly keeps the tote board display 312 up-to-date with the latest monitored data 310. The monitored data points 310 typically include part numbers, serial numbers, and version numbers for the hardware, operating system, and applications obscured within, as well as, for example, driving directions to a destination, schedules and appointments, conference call-in numbers, address and phone books, etc. Tote board display 312 does not have to be “synchronized” with monitored data points 310, it automatically reports the contents of monitored data points 310 on a continuing basis.

Tote board data display 312 can be implemented as individual photo images in a personal photo album, such as is common to all cellphones with cameras. The number of monitored data items possible is practically unlimited, as more and more “photos” or cards can easily be added and stored in smartphone 308.

Blades and blade systems that have been adapted for their use can also benefit from quick access display embodiments, like in FIGS. 1-3. Blades and blade systems don't often have local displays or monitors that would allow critical and important service and maintenance information to be locally selected, viewed or extracted from them. Certainly not when the blades are powered down.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A quick access display, comprising:
a mounting for an external surface of a portable device having its own primary display screen;
a secondary display screen supported by the mounting and that is functional and operational independent of any powered-on condition, or an operating system boot status, of said portable device;
a digital memory for providing information to the secondary display screen for viewing by a user, and that is accessible by said portable device and its operating system;
a power source independent of said portable device and providing for constant operational power to the secondary display screen and digital memory; and
a communications channel for receiving and forwarding said information from said portable device to the digital memory.

2. The quick access display of claim 1, further comprising:
a digital semiconductor technology included and substantially constituting the secondary display screen that requires small enough amounts of operating power that are practical to support with a coin-cell type watch battery over months of use.

3. The quick access display of claim 1, further comprising:
a digital semiconductor and non-volatile memory technology included and substantially constituting the digital memory that requires less than a hundred microwatts of operating power.

4. The quick access display of claim 1, further comprising:
a coin cell watch battery technology included and substantially constituting the power source and that can provide as much as 1000 milli-amp hours of operating power.

5. The quick access display of claim 1, further comprising:
an application program for execution by said portable device and its operating system, and that can forward selected data to the digital memory for later viewing as said information on the secondary display screen when said primary display is unavailable.

6. The quick access display of claim 1, further comprising:
an application program for execution by said portable device and its operating system, and that allows a user to select particular data for repetitive forwarding to the digital memory for later viewing as said information on the secondary display screen when said primary display is unavailable.

7. The quick access display of claim 1, further comprising:
a security device associated with the secondary display screen and for preventing unauthorized viewing of said information.

8. The quick access display of claim 1, further comprising:
a screen grabber for simulating and memorializing at least some portion of an image frame presented on said primary screen display on the secondary screen display.

9. The quick access display of claim 1, further comprising:
a device for displaying user-definable information not available to said operating system and that is native to a host machine's firmware.

10. The quick access display of claim 1, further comprising:
a barcode for presentation on the secondary screen display that represents identification and/or health data.

11. The quick access display of claim 1, wherein the mounting further comprises:
a flat thin membrane with a pressure sensitive adhesive surface for attachment to said laptop computer or notebook;
wherein, the secondary display, digital memory, power source, and communications device are disposed within the flat thin membrane.

12. A quick access display, comprising:
a first computer program for execution in a portable computer and providing for the selection and automatic reporting of data stored by said portable computer to an external display device; and
a second computer program for execution in a mobile phone, serving as said external display device, and providing for the selection and display of said data automatically reported from said portable computer;
wherein, the first and second computer programs operate together to establish a wireless communications channel for local transfers of said data.

13. The quick access display of claim 12, wherein said data includes at least one piece of information related to part, serial, or version numbers, phone or address books, conference call-in numbers, calendar, appointments, computer operational health, graphics, and barcodes.

14. The quick access display of claim 12, wherein the first computer program for execution in a portable computer comprises a plug and play device driver for a laptop computer.

15. The quick access display of claim 12, wherein the second computer program for execution in a mobile phone comprises a phone app.

16. The quick access display of claim 12, wherein the first computer program for execution in a portable computer installs as a plug and play device driver for a laptop computer as is downloadable from at least one of a USB device, Internet server, and computer applications store.

17. The quick access display of claim 12, wherein the second computer program for execution in a mobile phone comprises a phone app and is downloadable from at least one of a USB device, Internet server, and computer applications store.

18. The quick access display of claim 12, wherein the first computer program for execution in a portable computer enables a user to select particular data for repetitive forwarding to a digital memory in said mobile phone for later viewing as said information on a secondary display screen on said mobile phone when a primary display on said portable computer is unavailable.
